(19) United States
(12) Patent Application Publication
(10) Pub. No.: US 2016/0078326 A1
(43) Pub. Date: Mar. 17, 2016

(54) IMAGE PROCESSING APPARATUS AND NON-TRANSITORY COMPUTER READABLE MEDIUM

(71) Applicant: FUJI XEROX CO., LTD., Tokyo (JP)

(72) Inventor: Takahide Abe, Kanagawa (JP)

(21) Appl. No.: 14/611,314

(22) Filed: Feb. 2, 2015

(30) Foreign Application Priority Data
Sep. 11, 2014 (JP) 2014-184732

(51) Int. Cl. G06K 15/02

(52) U.S. Cl. CPC G06K 15/1806

(57) ABSTRACT

An image processing apparatus includes: a first conversion unit that converts into intermediate information for printing, a document which has a possibility of being printed; a second conversion unit that converts the intermediate information into information which can be printed by a printing apparatus; and a control unit that controls the first conversion unit to perform a process on the document which has the possibility of being printed and controls the second conversion unit not to perform a process in response to the document being not a complete edition and having no possibility that a content thereof is changed.

### CROSS-REFERENCE TO RELATED APPLICATIONS

This application is based on and claims priority under 35 USC 119 from Japanese Patent Application No. 2014-184732 filed on Sep. 11, 2014.

### BACKGROUND

### Technical Field

The present invention relates to an image processing apparatus and a non-transitory computer readable medium.

### SUMMARY

An aspect of the present invention provides an image processing apparatus including: a first conversion unit that converts into intermediate information for printing, a document which has a possibility of being printed; a second conversion unit that converts the intermediate information into information which can be printed by a printing apparatus: and a control unit that controls the first conversion unit to perform a process on the document which has the possibility of being printed and controls the second conversion unit not to perform a process in response to the document being not a complete edition and having no possibility that a content thereof is changed.

### BRIEF DESCRIPTION OF THE DRAWINGS

Exemplary embodiment(s) of the present invention will be described in detail based on the following figures, wherein

FIG. 1 is a conceptual module configuration diagram illustrating a configuration example according to Embodiment 1;

FIG. 2 is a diagram illustrating a system configuration example in a case where the present embodiment is realized;

FIG. 3 is a flowchart illustrating a processing example according to Embodiment 1;

FIG. 4 is a flowchart illustrating a processing example according to Embodiment 1;

FIG. 5 is a diagram illustrating a data structure example of an attribute table;

FIG. 6 is a flowchart illustrating a processing example according to Embodiment 1;

FIG. 7 is a diagram illustrating a data structure example of a job ID-intermediate data or raster image correspondence table;

FIG. 8 is a flowchart illustrating a processing example according to Embodiment 2;

FIG. 9 is a flowchart illustrating a processing example according to Embodiment 2;

FIG. 10 is a flowchart illustrating a processing example according to Embodiment 3; and

FIG. 11 is a block diagram illustrating a hardware configuration example of a computer which realizes the present embodiment.

### DETAILED DESCRIPTION

First, prior to description of the present embodiment, a description will be made of a printing service which is the premise of the present embodiment or employs the present embodiment. In addition, this description is intended to facilitate better understanding of the present embodiment.

There is commercial printing in which a page description language (PDL) file such as PostScript (PS) or a portable document format (PDF), or various format files are entrusted from customers as a printing job, and are printed up until the due date.

In addition, there is also a department which performs printing up until the due date in a company or the like, and printing from a small number of copies to a large number of copies such as manuals is performed.

In this printing service business, it is important that a designated amount of printed matters are delivered at the designated delivery date, and it is natural that printing is performed before the due date.

However, drawbacks may occur even in the printing before the delivery date. In other words, the storage cost and responsibility of maintenance occur to someone until a customer who has requested printing finally distributes printed matters to customers thereof. In a case where the printed matters are delivered to the customer before the designated delivery date, the customer has to store a large number of printed matters during a period leading up to the distribution time, and thus there is a problem in securing a storage location. Although a service bureau stores the printed matters, the same problem of securing a storage location exists.

Therefore, from this viewpoint, as optimum timing for outputting a job, the outputting is finished in a form of matching the delivery date, but, in commercial printing or in-house printing, the requested due dates frequently overlap each other, and particularly, printing requests frequently concentrate at the end of the month due to sending of bills, or the like.

In relation to a printing job, there is a case where a document may be corrected from a requesting side between the time of document input (reception of a document to be printed; document need not be a complete edition) and the delivery date (delivery of printed matters) depending on the content thereof, and thus the following is required to be taken into consideration depending on the document.
There is a possibility that the content may be modified up to right before the printing due date.
There is a possibility that a replacement may be requested in the page units up to right before the printing due date.
There is a possibility that an element such as shading which has no relation to the content of a document but influences a finish of the document may be changed up to right before the printing due date.

Hereinafter, with reference to the drawings, various embodiments suitable for implementing the present invention will be described.

### Embodiment 1

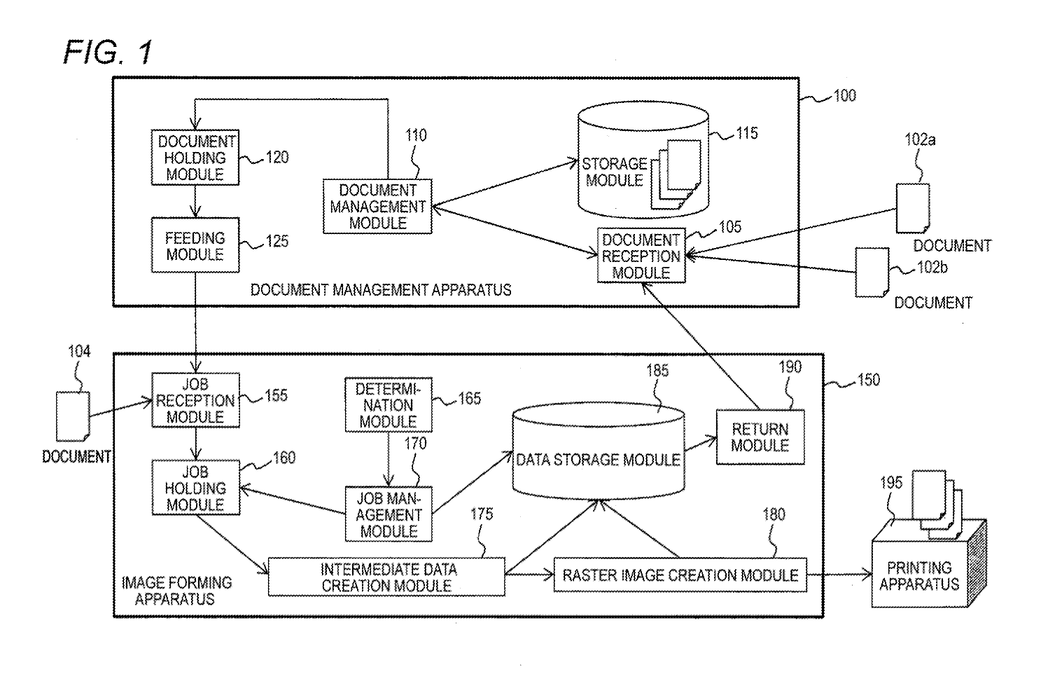

FIG. 1 is a conceptual module configuration diagram illustrating a configuration example according to Embodiment 1.

In addition, the module indicates components such as software (computer program) and hardware which may be generally and logically divided. Therefore, the module in the present embodiment indicates not only a module in a computer program but also a module in a hardware configuration. Accordingly, the present embodiment also includes description of a computer program for causing a computer to function as the module (a program for causing a computer to execute the respective procedures, a program for causing a computer to function as the respective units, or a program for causing a computer to realize the respective functions), a system, and a method. For convenience of the description, although the term “store”, or “make store”, and terms equivalent to them are used, these terms mean that, in a case of a computer program, it is stored in a storage device or is controlled so as to be stored in the storage device. In addition, the module may correspond to a function in a one-to-one relationship. In a case of mounting, a single module may be configured by a single program, plural modules may be configured by a single program, or conversely a single module may be configured by plural programs. In addition, plural modules may be executed by a single computer, or a single module may be executed by plural computers using computers in distributed or parallel environments. Further, other modules may be included in a single module. Hereinafter, the term “connection” is used not only in a case of physical connection but also in a case of logical connection (data transmission and reception, instruction, reference relationship between data, and the like). The term “predefined” indicates being defined before a process which is a target, and is used to include a meaning of being defined according to circumstances or states at that time or according to circumstances or states hitherto as long as the process which is a target is not performed, even after a process according to the present embodiment starts including a state where the process according to the present embodiment does not start. In a case where there are plural “predefined values”, the values may be different, or two or more values (of course, including all the values) may be the same. Further, the phrase having the meaning that “in a case of A, B is performed” is used means that “whether or not there is A is determined, and if it is determined that there is A, B is performed”. However, a case where it is unnecessary to determine whether or not there is A is excluded.

In addition, the system or the apparatus includes not only a case where plural computers, plural pieces of hardware, plural apparatuses, and the like are configured to be connected to each other via communication unit such as a network (including communication connection of one-to-one correspondence) but also a case where it is realized by a single computer, a piece of hardware, a single apparatus, and the like. The “apparatus” and the “system” are used as terms having the same meaning. Of course, the “system” does not include social “structures” (social systems) which are merely artificial arrangements.

In addition, for each process performed by each module, or for each process in a case where plural processes are performed in a module, information which is a target is read from a storage device, the process is performed, and then the process result is written in the storage device. Therefore, there are cases where the description of reading from the storage device before the process and writing in the storage device after the process may be omitted. The storage device here may include a hard disk, a random access memory (RAM), an external storage medium, a storage device via a communication line, a register in a central processing unit (CPU), or the like.

In a system configured by a document management apparatus 100, an image forming apparatus 150, and a printing apparatus 195 according to the present embodiment, a document 102 or a document 104 is printed by the printing apparatus 195. As illustrated in the example of FIG. 1, the document management apparatus 100 includes a document reception module 105, a document management module 110, a storage module 115, a document holding module 120, and a feeding module 125. The image forming apparatus 150 includes a job reception module 155, a job holding module 160, a determination module 165, a job management module 170, an intermediate data creation module 175, a raster image creation module 180, a data storage module 185, and a return module 190. The document management apparatus 100 may perform a printing job (an input process of a document including the delivery date of printed matters, or a printing instruction) on the image forming apparatus 150.

In addition, module configurations in embodiments which will be described later are equivalent to the module configuration illustrated in the example of FIG. 1. A description will be made of a process of holding a document in this configuration by using an example of Embodiment 1. A description will be made of a process of editing a document in this configuration by using an example of Embodiment 2. A description will be made of a process of printing a document in this configuration by using an example of Embodiment 3.

The image forming apparatus 150 analyzes a structure of a document in relation to a printing job so as to create data which is decomposed into objects forming a page, and holds the data as intermediate data. In other words, all (generation of a raster image which will be described later) or a part (generation of intermediate data) of an image generation process is performed in advance during a period (for example, when there is a margin in processing performance of the image forming apparatus 150) up to the delivery date.

Any one of the following aspects of a printing job is held in the image forming apparatus 150.
A printing job is held in a state of being delivered. In this case, when a printing process is subsequently performed according to the delivery date, it is necessary to perform a process of generating intermediate data from a printing target document and a process of generating a raster image from the intermediate data.
A raster image of a printed matter is also created and held. In this case, when a printing process is subsequently performed according to the delivery date, printing can be directly started by using the raster image. However, a holding region for holding the raster image is frequently increased. In addition, in a case where a capacity of the raster image is large, the transmission cost is also increased when the raster image is transmitted to the document management apparatus 100.
A printing job is analyzed so that intermediate data formed by objects is created and held before a raster image is generated. In this case, when a printing process is subsequently performed according to the delivery date, it is necessary to perform a process of generating a raster image from the intermediate data in order to perform printing. In addition, since the intermediate data is an object, a capacity thereof is small, and the cost (including the above-described transmission cost) for holding the intermediate data is lower than in a case of the raster image.

A description will be made of a comparison between a raster image and intermediate data.

Since the raster image has a large amount of data, the cost for holding the raster image is high, but, since data is just being transmitted to the printing apparatus 195 during printing, the processing time from reading of the held data (raster image) to printing output is short.

Since the intermediate data has a small amount of data, the cost for holding the data is low, however, but, since, during printing, it is necessary to perform a heavy rasterization process which takes time and then to transmit the rasterized image (raster image) to the printing apparatus 195, processing time from reading of the held data (intermediate data) to printing output is long (accurately, the processing time is longer than in a case of creating a raster image in the same printing job).

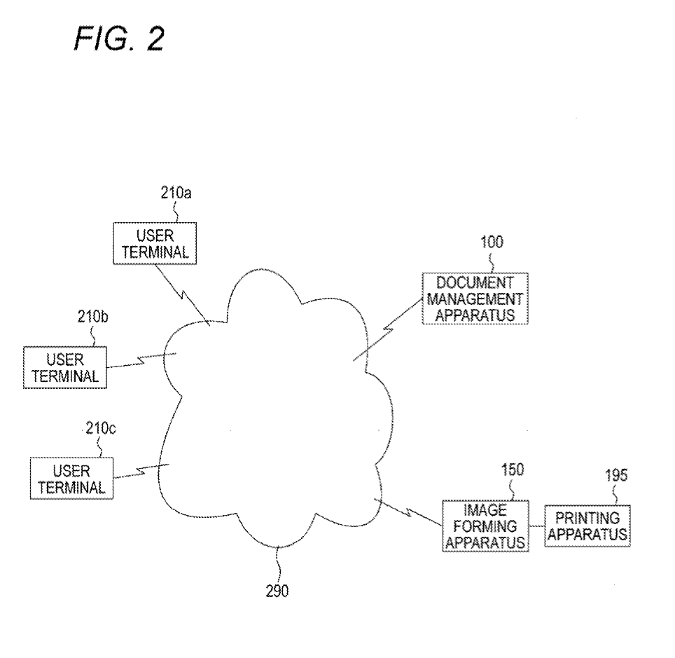

The document reception module 105 is connected to the document management module 110 and the return module 190 of the image forming apparatus 150, and receives a document 102a and a document 102b. The document reception module 105 receives the document 102 (document data) which is input from an external apparatus (a user terminal 210 or the like which will be described later in FIG. 2) and registers the document in the storage module 115 of the document management apparatus 100. In addition, the document reception module 105 receives document data (intermediate data or a raster image which will be described later) which is delivered from the return module 190 of the image forming apparatus 150 and has been processed by the image forming apparatus 150 and information regarding the document data, and delivers the document data and the information to the document management module 110.

The document management module 110 is connected to the document reception module 105, the storage module 115, and the document holding module 120. The document management module 110 holds the document data received by the document reception module 105 in the storage module 115 along with attribute data regarding the document. In addition, the document management module 110 delivers the document held in the storage module 115 to the document holding module 120. Further, the processed document data and the information regarding the document data which are delivered from the return module 190 of the image forming apparatus 150 via the document reception module 105 are held in the storage module 115 in association with the original document data which is held in the storage module 115.

The storage module 115 is connected to the document management module 110. The storage module 115 holds document data and attribute data regarding the document data. The attribute data includes, for example, the printing delivery date, a printing specification, and data having undergone an image generation process.

The document holding module 120 is connected to the document management module 110 and the feeding module 125. The document holding module 120 temporarily holds data which is delivered from the document management module 110, monitors whether or not there is a vacancy in the feeding module 125 (substantially, a vacancy of the job reception module 155 of the image forming apparatus 150), and delivers the document data to the feeding module 125 when a vacancy is generated.

The feeding module 125 is connected to the document holding module 120, and the job reception module 155 of the image forming apparatus 150. The feeding module 125 feeds the document data to the job reception module 155 of the image forming apparatus 150.

The job reception module 155 is connected to the job holding module 160, and the feeding module 125 of the document management apparatus 100. The job reception module 155 receives the document data from the feeding module 125 of the document management apparatus 100 or the document 104 (PDL data or the like) from an external apparatus (a user terminal 210 or the like which will be described later in FIG. 2), and registers the data in the image forming apparatus 150 as a printing job. In addition, in a case where the document 104 is received from the external apparatus, this leads to a printing job (in which the printing due date may not be designated) indicating direct printing.

The job holding module 160 is connected to the job reception module 155, the job management module 170, and the intermediate data creation module 175. The job holding module 160 holds a registered printing job. In addition, the printing job includes document data (here, the fed document 102 and document 104, and intermediate data and a raster image which will be described later).

The determination module 165 is connected to the job management module 170. The determination module 165 analyzes the document data which is fed from the document management apparatus 100 and is held in the job holding module 160 via the job reception module 155, and determines a process to be performed depending on its property.

The determination module 165 determines a holding state of each printing job depending on an attribute of the printing job. An attribute used for the determination is as follows. In addition, this attribute indicates a possibility of change which is performed between the time of document input (the time of feeding of a printing job) and the delivery date.

Complete Edition (in which an Access Right May be Set to be “Read-Only”)

Since document data has not been edited, a raster image may also be generated.

Page Unit Replaceable

A raster image may also be generated. In a case where a page is replaced, reprocessing is performed in the page unit, and a raster image of only the replaced page may be updated.

Content (Content of a Document) Changeable

Since reprocessing is necessary due to a change in content, a printing job is held as it is without performing preprocessing (without performing processes in the intermediate data creation module 175 and the raster image creation module 180).

Configuration Changeable

This indicates that there is a possibility that imposition or page allocation may be changed. Intermediate data may also be created.

Setting Adjustable

This indicates that content or a structure of a printing job is not changed, but there is a possibility that a color related process (for example, shade settings (for example, emphasis of a reddish color, or setting of sepia), and binarization) may be changed. Intermediate data may also be created.

In addition, information is required to be added to these attributes through an operation performed by a person who instructs that the document 102 or the document 104 be fed when the document is input.

Further, the attribute “page unit replaceable” is not used as a determination target in Embodiment 1 but is used in Embodiment 2 and Embodiment 2-2.

The job management module 170 is connected to the job holding module 160, the determination module 165, and the data storage module 185. In relation to a document which may possibly be printed and is not a complete edition and whose content has no possibility of being changed, the job management module 170 controls the intermediate data creation module 175 to process the document and controls the raster image creation module 180 not to process the document. As a “case of a document which may possibly be printed and whose content has no possibility of being changed”, for example, there is a “case where information (also referred to as an attribute, a flag, or the like) indicating that content of the document has no possibility of being changed is correlated with the document which may possibly be printed”.

In addition, in a case where a document which may possibly be printed is a complete edition, the job management module 170 may control the intermediate data creation module 175 and the raster image creation module 180 to process the document.

Further, in relation to a document which may possibly be printed and is not a complete edition and whose imposition or page allocation may possibly be changed, the job management module 170 may control the intermediate data creation module 175 to process the document and may control the raster image creation module 180 not to process the document.

Furthermore, in relation to a document which may possibly be printed and is not a complete edition and whose color processing may possibly be changed, the job management module 170 may control the intermediate data creation module 175 to process the document and may control the raster image creation module 180 not to process the document.

Specifically, the job management module 170 adds a determination result from the determination module 165 to an attribute of a printing job, and starts processing of the printing job. In addition, the job management module 170 extracts the printing job which is processed on the basis of the determination result from the data storage module 185, and delivers the printing job to the return module 190.

The intermediate data creation module 175 is connected to the job holding module 160, the raster image creation module 180, and the data storage module 185. The intermediate data creation module 175 converts a document which may possibly be printed into intermediate information for printing the document. Specifically, a structure of the document is analyzed, and intermediate data which is decomposed into objects forming a page is created. The intermediate information (hereinafter, also referred to as intermediate data) is data into which the document is converted and is data (which thus is not a raster image) for generating data (hereinafter, also referred to as a raster image) which can be directly analyzed by the printing apparatus 195 and can thus be used for printing, and has data capacity smaller than a size of a raster image. For example, in relation to intermediate data, techniques disclosed in JP-A-2012-200934, JP-A-2012-200955, and JP-A-2012-200956 may be used. The intermediate data may be data which is formed by only straight line drawing command data, and data which is run-length data of a raster image. Generally, among processes regarding a printing job, many processes in the intermediate data creation module 175 take time. Therefore, in order to increase a degree of freedom of a schedule, the processes in the intermediate data creation module 175 are preferably performed in advance before a printing process (this printing process is preferably performed right before the delivery date) in the printing apparatus 195.

The raster image creation module 180 is connected to the intermediate data creation module 175, the data storage module 185, and the printing apparatus 195. The raster image creation module 180 converts the intermediate information into a raster image which is information which can be printed by the printing apparatus 195. Specifically, a raster image of a page which is sent to the printing apparatus 195 is created. In addition, the intermediate information is generated by the intermediate data creation module 175 but may be delivered from the intermediate data creation module 175, and may be intermediate information stored in the data storage module 185 or the storage module 115.

The information converted by the intermediate data creation module 175 and the raster image creation module 180 is stored until printing is performed. In Embodiment 1, the information is stored in the storage module 115, and, in Embodiment 1-2, the information is stored in the data storage module 185. In addition, the storage state is maintained at least in a case where the document is changed or until the document is printed. After printing is performed, the information may be deleted from the storage module 115 or the data storage module 185.

The data storage module 185 is connected to the job management module 170, the intermediate data creation module 175, the raster image creation module 180, and the return module 190). The data storage module 185 holds intermediate data generated by the intermediate data creation module 175, or a raster image generated by the raster image creation module 180.

The return module 190 is connected to the data storage module 185, and the document reception module 105 of the document management apparatus 100. The return module 190 returns document data (intermediate data or a raster image) processed by the intermediate data creation module 175 or the raster image creation module 180 and information regarding the document data to the document management apparatus 100. In addition, a re-feeding time may be included in the information regarding the document data.

The printing apparatus 195 is connected to the raster image creation module 180 of the image forming apparatus 150. The printing apparatus 195 prints a raster image. The printing apparatus 195 is a printer, and, particularly, may be a so-called production printer.

FIG. 2 is a diagram illustrating a system configuration example in a case where the present embodiment is realized.

The document management apparatus 100, the image forming apparatus 150, a user terminal 210a, a user terminal 210b, and a user terminal 210c are connected to each other via a communication line 290, and the image forming apparatus 150 is connected to the printing apparatus 195. The communication line 290 may employ wireless communication, wired communication, and a combination thereof, and may use, for example, the Internet as a communication infrastructure. The user terminal 210a, the user terminal 210b, and the user terminal 210c input the document 102 and the document 104 which are printing targets to the document management apparatus 100 or the image forming apparatus 150.

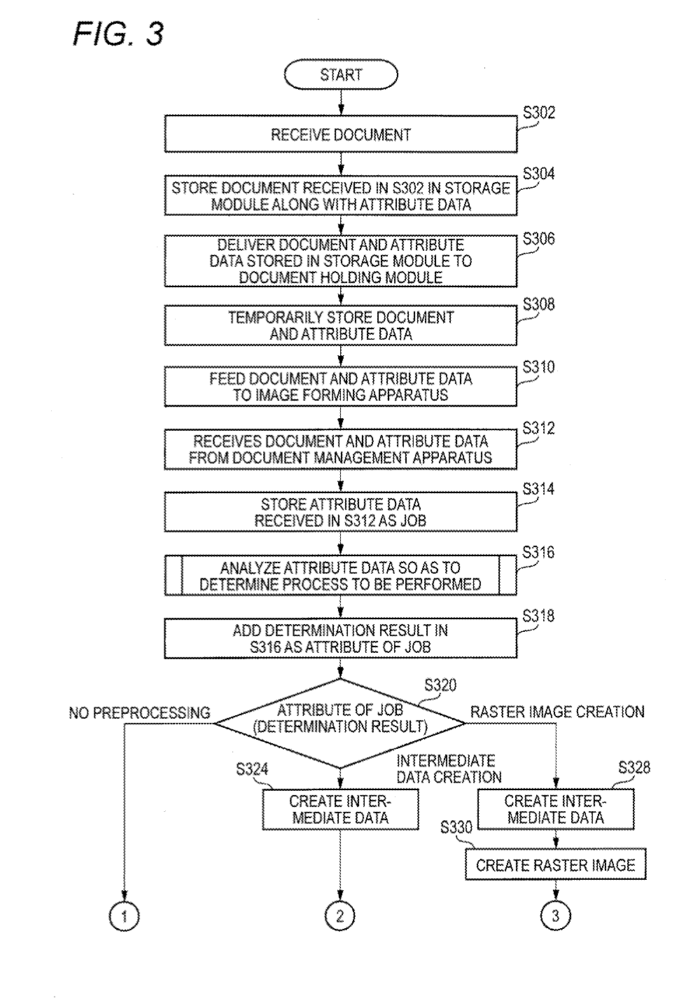

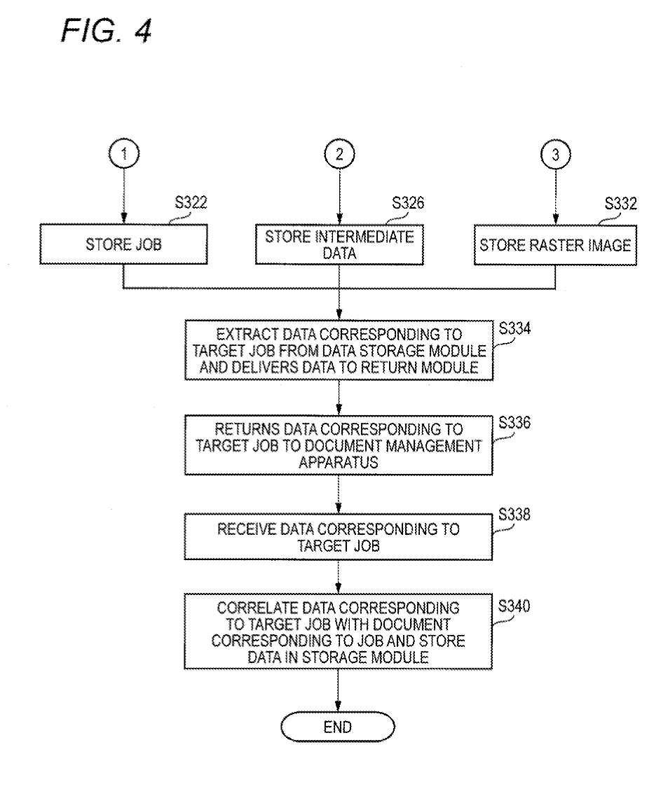

FIGS. 3 and 4 are flowcharts illustrating a processing example according to Embodiment 1.

In step S302, the document reception module 105 receives the document 102.

In step S304, the document management module 110 stores the document 102 received in step S302 in the storage module 115 along with attribute data.

In step S306, the document management module 110 delivers the document 102 and the attribute data stored in the storage module 115 to the document holding module 120.

In step S308, the document holding module 120 temporarily stores the document 102 and the attribute data.

In step S310, the feeding module 125 feeds the document 102 and the attribute data to the image forming apparatus 150.

In step S312, the job reception module 155 receives the document 102 and the attribute data from the document management apparatus 100.

In step S314, the job holding module 160 stores the attribute data received in step S312 as a printing job.

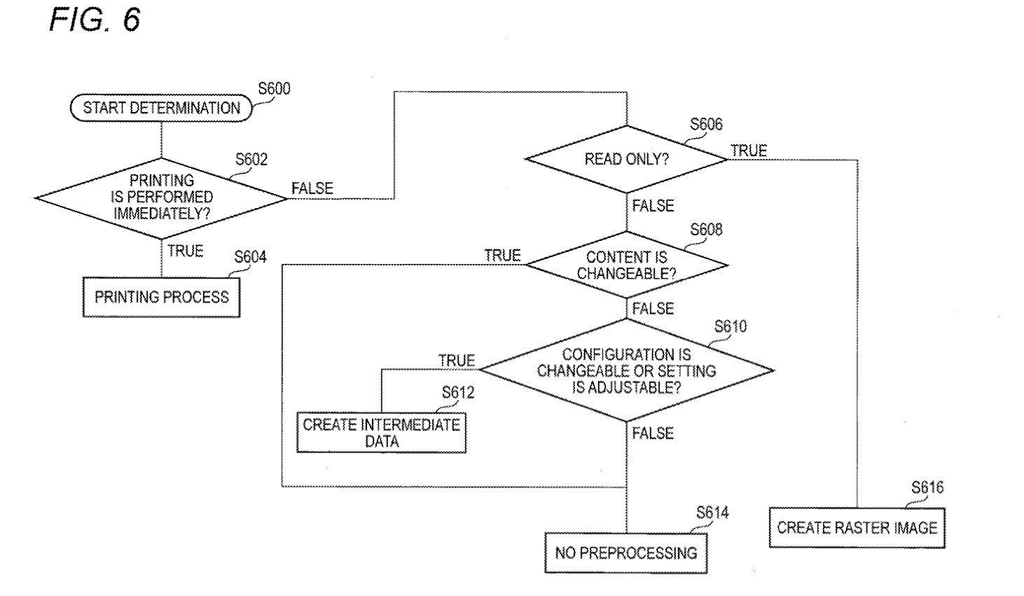

In step S316, the determination module 165 analyzes the attribute data so as to determine a process to be performed. Details of the process in step S316 will be described later with reference to a flowchart illustrated in an example of FIG. 6.

In step S318, the job management module 170 adds a determination result in step S316 as an attribute of the printing job.

In step S320, the job management module 170 determines the attribute (determination result) of the printing job. If the attribute is “no preprocessing”, the flow proceeds to step S322, if the attribute is “intermediate data creation”, the flow proceeds to step S324, and if the attribute is “raster image creation”, the flow proceeds to step S328.

In step S322, the data storage module 185 stores the printing job itself.

In step S324, the intermediate data creation module 175 creates intermediate data.

In step S326, the data storage module 185 stores the intermediate data.

In step S328, the intermediate data creation module 175 creates intermediate data.

In step S330, the raster image creation module 180 creates a raster image.

In step S332, the data storage module 185 stores the raster image.

In step S334, the job management module 170 extracts data corresponding to the target printing job from the data storage module 185, and delivers the data to the return module 190.

In step S336, the return module 190 returns the data corresponding to the target printing job to the document management apparatus 100.

In step S338, the document reception module 105 receives the data corresponding to the target printing job.

In step S340, the document management module 110 correlates the data corresponding to the target printing job with the document 102 corresponding to the printing job and stores the data in the storage module 115.

Subsequently, the document management module 110 instructs the image forming apparatus 150 to perform printing so as to be in time for the printing due date. In a case where there is intermediate data or a raster image correlated with the document, the intermediate data or the raster image is added to the printing instruction and is delivered.

In a case where neither of intermediate data and a raster image are not correlated with the document (in a case where the determination result in step S316 is “no preprocessing”), the document is added to the printing instruction and is delivered.

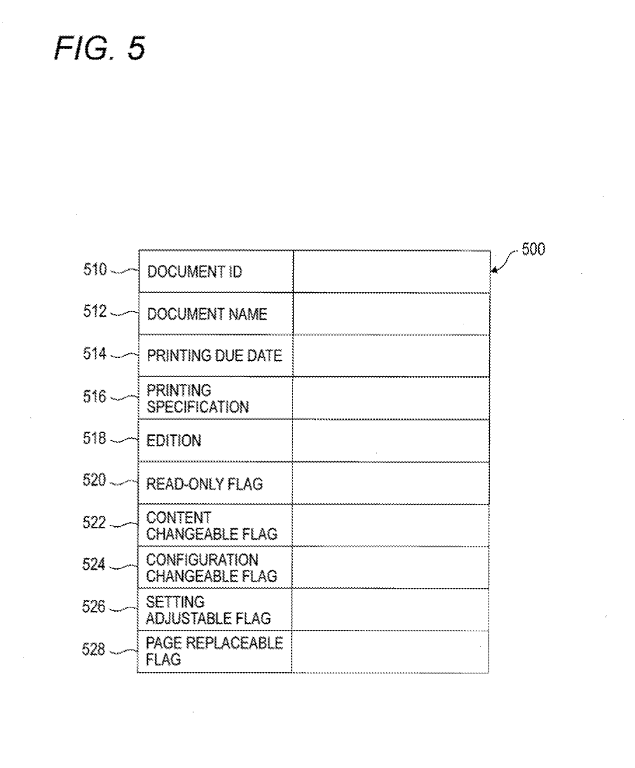

FIG. 5 is a diagram illustrating a structure example of an attribute table 500. The attribute table 500 is added as an attribute of a printing job.

The attribute table 500) includes, for example, a document ID column 510, a document name column 512, a printing due date column 514, a printing specification column 516, an edition column 518, a read-only flag column 520, a content changeable flag column 522, a configuration changeable flag column 524, a setting adjustable flag column 526, and a page replaceable flag column 528.

The document ID column 510 stores information (document identification: ID) for uniquely identifying a document in the present embodiment. The document name column 512 stores a document name of the document. The printing due date column 514 stores the printing due date of the document. The document management apparatus 100 performs a scheduling process for starting a printing process so as to be in time for the printing due date (for example, so that a printing process is finished right before the printing due date, a storage period of printed matters is shortened, and an editable period is lengthened from the time of document input). The printing specification column 516 stores a printing specification of the document. The printing specification includes, for example, a printing configuration (imposition, page allocation, or the like), page settings (a process related to a color, or the like). The edition column 518 stores an edition of the document. The read-only flag column 520 stores a flag indicating whether or not the document is read-only. The read-only flag column 520 may store a flag indicating whether or not the document is a final edition (complete edition). This is because the final edition indicates that there is no more editing. In addition, the read-only flag column 520 may store information indicating an access right to a document. This is because, in a case where an access right is “read-only”, there is no more editing. The content changeable flag column 522 stores a flag indicating whether or not content of the document is changeable. The configuration changeable flag column 524 stores a flag indicating whether or not a configuration of the document is changeable. The setting adjustable flag column 526 stores a flag indicating whether or not settings of the document are adjustable. The page replaceable flag column 528 stores a flag indicating whether or not a page of the document is replaceable.

FIG. 6 is a flowchart illustrating a processing example according to Embodiment 1. FIG. 6 illustrates a processing example in step S316 of the flowchart illustrated in the example of FIG. 3.

In step S600, a determination is started.

In step S602, it is determined whether or not printing is performed immediately. If the direct printing is performed immediately, the flow proceeds to step S604, otherwise, the flow proceeds to step S606. As the case where the direct printing is performed immediately there are a case of right before the delivery date (a predefined period from the delivery date), a case of a printing job in which the delivery date is not designated (for example, in a case where the image forming apparatus 150 receives the document 104 from apparatuses other than the document management apparatus 100), and the like.

In step S604, a printing process is performed. Processes are performed by the intermediate data creation module 175 and the raster image creation module 180, and the printing process is performed by the printing apparatus 195.

In step S606, it is determined whether or not an attribute of the document is read-only. If the attribute is read-only, the flow proceeds to step S616, otherwise, the flow proceeds to step S608.

In step S608, it is determined whether or not the attribute of the document is content changeable. If the attribute is content changeable, the flow proceeds to step S614, and, otherwise, the flow proceeds to step S610.

In step S610, it is determined whether or not the attribute of the document is configuration changeable or setting adjustable. If the attribute is configuration changeable or setting adjustable, the flow proceeds to step S612, otherwise, the flow proceeds to step S614.

In step S612, “intermediate data creation” is determined. A process is performed by the intermediate data creation module 175.

In step S614, “no preprocessing” is determined. No process is performed by the intermediate data creation module 175 and the raster image creation module 180.

In step S616. “raster image creation” is determined. A process is performed by the raster image creation module 180.

In step S612, step S614 and step S616, printing is awaited until the time of the printing process. This determination result is added to the printing job by the job management module 170.

The job management module 170 preferentially processes a printing job in which a printing process is designated.

The job management module 170 monitors a state of the image forming apparatus 150, and processes a printing job to which the determination of intermediate data creation or raster image creation is added in a case where the intermediate data creation module 175 or the raster image creation module 180 does not perform a process.

The job management module 170 processes a job to which the determination of raster image creation is added, preferentially to a job to which the determination of intermediate data creation is added.

The data storage module 185 temporarily preserves data created by the intermediate data creation module 175 or the raster image creation module 180.

Determination information (including information indicating whether or not a determination is completed) and processing time and date information are added to created document data (intermediate data or a raster image). In a case where document data is not created, determination information (including information indicating whether or not a determination is completed) and processing time and date information are returned from the return module 190 to the document reception module 105.

The document reception module 105 receives the document data, the determination information, and the like, which are then delivered to the document management module 110. The document management module 110 determines whether or not the document is a new document on the basis of the added determination information, and adds the document data, the determination information, and the like to the document data stored in the storage module 115 as attributes in a case where document data having undergone preprocessing is determined. At this time, the created intermediate data or raster image is also added as one of the attributes.

In addition, in a case where the printing due date is near, the document management apparatus 100 may deliver the attributes including intermediate data or a raster image to the image forming apparatus 150 as a printing job.

### Embodiment 1-2

As a different method of realizing Embodiment 1, created document data may be treated as follows.

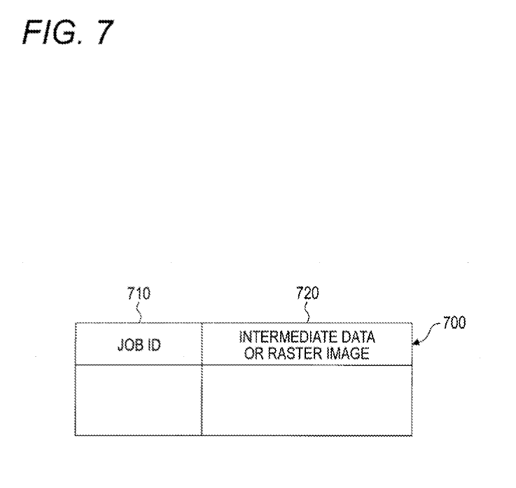

Data (intermediate data or a raster image) created by the intermediate data creation module 175 or the raster image creation module 180 is preserved in the data storage module 185, and determination information (including information indicating whether or not a determination is completed), processing time and date information, and a job ID are returned from the return module 190 to the document reception module 105 of the document management apparatus 100. In addition, for example, a job ID-intermediate data or raster image correspondence table 700 is stored in the data storage module 185. FIG. 7 is a diagram illustrating a structure example of the job ID-intermediate data or raster image correspondence table 700. The job ID-intermediate data or raster image correspondence table 700) includes, for example, a job ID column 710 and an intermediate data or raster image column 720. The job ID column 710 stores information (job ID) for uniquely identifying a printing job in the present embodiment. The intermediate data or raster image column 720 stores intermediate data or a raster image corresponding to the printing job. Intermediate data or a raster image itself may be stored, and a location (a file name or a uniform resource locator (URL)) where intermediate data or a raster image is stored may be stored.

The document reception module 105 receives information and delivers the information to the document management module 110 so that each piece of information is added to a related document stored in the storage module 115 as an attribute.

In addition, in a case where the printing due date is near, the preprocessed job ID is added to the printing job, and the printing job is fed from the document management apparatus 100 to the image forming apparatus 150. The image forming apparatus 150 extracts intermediate data or a raster image by using the job ID-intermediate data or raster image correspondence table 700 on the basis of the job ID added to the printing job, and performs a printing process.

### Embodiment 2

Embodiment 2 employs the module configuration illustrated in the example of FIG. 1. A description will be made of a process of editing a document in the configuration of Embodiment 1.

The job management module 170 controls the intermediate data creation module 175 or the raster image creation module 180 to process a document, in a case where the document is changed after the intermediate data creation module 175 or the raster image creation module 180 processes the document, and when the intermediate data creation module 175 or the raster image creation module 180 has processed the document before being changed.

In relation to document data of which intermediate data or a raster image is created, a printing image is presented by using a preview in response to a user's operation.

In addition, a document (a document which is input, or a document having undergone preprocessing) of which document data has already been created can be changed in response to a user's operation.

In such a case, a change which is not required to be reprocessed in the image forming apparatus 150 can be unconditionally performed.

For example, in relation to a document of which a configuration changeable attribute value is “true” and intermediate data creation is finished, changing a document configuration such as changing an imposition setting or inserting a blank page can be unconditionally performed.

In addition, in relation to a document of which a configuration changeable attribute value is “true” and intermediate data creation is finished, changing a shade setting or the like can be unconditionally performed.

However, if content of a document of which intermediate data has been created is to be changed, recreation of intermediate data is necessary. Since a processing time for the recreation is required, there is a case where a schedule is required to be adjusted and thus changing the due date is necessary.

In a case where content or an attribute of document data is changed, the document management module 110 of the document management apparatus 100 sends a determination result attribute of the document and the changed content to the determination module 165 of the image forming apparatus 150 so as to determine whether or not reprocessing in the image forming apparatus 150 is necessary.

In a case where it is determined that reprocessing is necessary by the determination module 165 of the image forming apparatus 150, the document management apparatus 100 deletes existing determination information and performs the above-described document registration flow according to Embodiment 1 again.

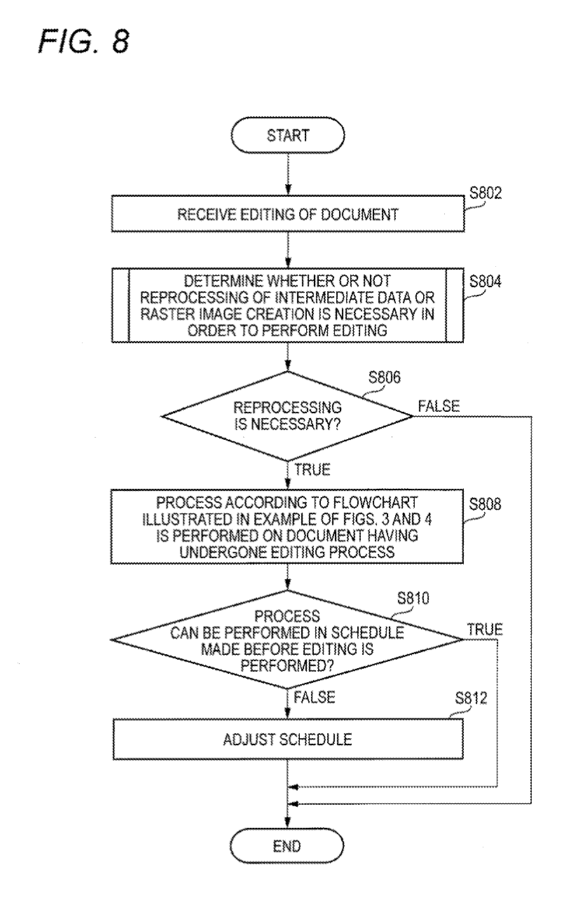

FIG. 8 is a flowchart illustrating a processing example according to Embodiment 2.

In step S802, the job reception module 155 receives editing of a document.

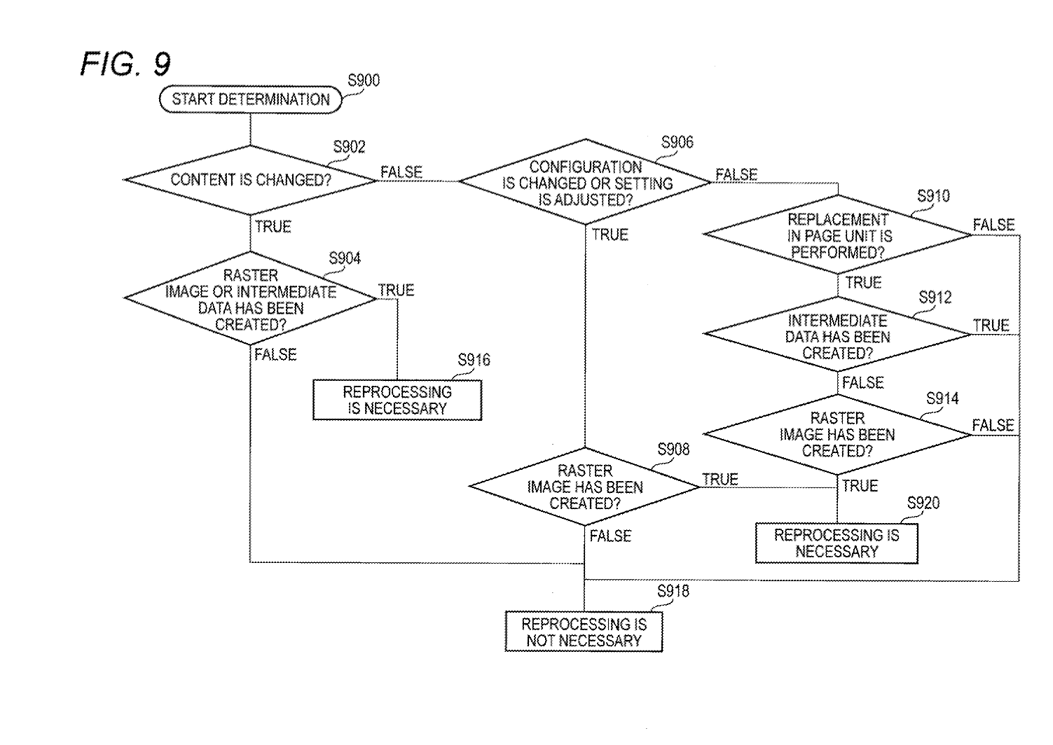

In step S804, the determination module 165 determines whether or not reprocessing of intermediate data or raster image creation is necessary in order to perform editing. Details of the process in step S804 will be described later with reference to a flowchart illustrated in an example of FIG. 9.

In step S806, it is determined whether or not reprocessing is necessary. If the reprocessing is necessary, the flow proceeds to step S808, otherwise, the process is finished (step S899).

In step S808, the process (preprocess) according to the flowchart illustrated in the example of FIGS. 3 and 4 is performed on the document having undergone the editing process.

In step S810, it is determined whether or not the process can be performed in a schedule made before the editing is performed. If the process can be performed, the process is finished (step S899), otherwise, the flow proceeds to step S812.

In step S812, the schedule is adjusted.

FIG. 9 is a flowchart illustrating a processing example according to Embodiment 2. FIG. 9 illustrates a processing example in step S804 of the flowchart illustrated in the example of FIG. 8.

In step S900, a determination is started.

In step S902, it is determined whether or not content is changed. If the content is changed, the flow proceeds to step S904, otherwise, the flow proceeds to step S906.

In step S904, it is determined whether or not raster image or intermediate data creation is completed. If the creation is completed, the flow proceeds to step S916, otherwise, the flow proceeds to step S918.

In step S906, it is determined whether or not a configuration is changed or a setting is adjusted. If the configuration is changed or the setting is adjusted, the flow proceeds to step S908, otherwise, the flow proceeds to step S910.

In step S908, it is determined whether or not a raster image has been created. If the raster image has been created, the flow proceeds to step S920, otherwise, the flow proceeds to step S918.

In step S910, it is determined whether or not replacement in the page unit is performed. If the replacement is performed in the page unit, the flow proceeds to step S912, otherwise, the flow proceeds to step S918.

In step S912, it is determined whether or not intermediate data has been created. If the intermediate data has been created, the flow proceeds to step S918, otherwise, the flow proceeds to step S914.

In step S914, it is determined whether or not a raster image has been created. If the raster image has been created, the flow proceeds to step S920, otherwise, the flow proceeds to step S918.

In step S916, it is determined whether or not reprocessing is necessary.

In step S918, it is determined that the reprocessing is not necessary.

In step S920, it is determined that the reprocessing is necessary.

If “true” in step S912, the reprocessing is not necessary, and replacement in the page unit may be performed on the intermediate data.

If “false” in step S914, the reprocessing is not necessary. Replacement in the page unit may be performed on original data.

If “true” in step S914, reprocessing is necessary. Replacement in the page unit is performed on the original data, and then reprocessing for creating a raster image is performed.

### Embodiment 2-2

As a different method of realizing Embodiment 2, created document data may be treated as follows.

Data (intermediate data or a raster image) created by the intermediate data creation module 175 or the raster image creation module 180 is preserved in the data storage module 185, and determination information (including information indicating whether or not a determination is completed), processing time and date information, and a job ID are returned from the return module 190 to the document reception module 105 of the document management apparatus 100. In addition, for example, the job ID-intermediate data or raster image correspondence table 700 is stored in the data storage module 185.

The document reception module 105 receives information and delivers the information to the document management module 110 so that each piece of information is added to a related document stored in the storage module 115 as an attribute.

In addition, in a case where the printing due date is near, the preprocessed job ID is added to the printing job, and the printing job is fed from the document management apparatus 100 to the image forming apparatus 150. The image forming apparatus 150 extracts intermediate data or a raster image by using the job ID-intermediate data or raster image correspondence table 700 on the basis of the job ID added to the printing job, and performs a printing process.

In a case where it is determined that reprocessing is necessary by the determination module 165 of the image forming apparatus 150, the document management apparatus 100 deletes existing determination information and requests the image forming apparatus 150 to reprocess a job with the job ID correlated with the document.

### Embodiment 3

Embodiment 3 employs the module configuration illustrated in the example of FIG. 1. A description will be made of a process of printing a document having data which is created in advance in the configuration of the above-described embodiment.

In a case where a printing process of a document is received, when the document has been processed by the intermediate data creation module 175, the job management module 170 controls the raster image creation module 180 to process the document so that a process result by the raster image creation module 180 is printed by the printing apparatus 195, and when the document has been processed by the raster image creation module 180, the job management module 170 performs control so that a process result by the raster image creation module 180 is printed by the printing apparatus 195. The “case where a printing process of a document is received” corresponds to a printing instruction which is given before the designated printing due date and occurs at a predefined time (a scheduled start time which is set to secure a processing time calculated according to printed content).

The document management apparatus 100 feeds a printing job to the image forming apparatus 150 according to a schedule of the printing job.

In the document management apparatus 100, the document management module 110 extracts document data from the storage module 115 according to the schedule, and the document data is fed to the image forming apparatus 150 from the feeding module 125 via the document holding module 120.

At this time, if there is processed data (intermediate data or a raster image), the data is added to the document data and is fed to the image forming apparatus 150 along with determination information.

In the image forming apparatus 150, a process is further performed by using the determination information and the processed data, and printing is performed.

In a case where the determination information indicating “no preprocessing”, intermediate data and a raster image are created, and then a printing process is performed.

In a case where the determination information indicates “intermediate data created”, a raster image is created, and then a printing process is performed.

In a case where the determination information indicates “raster image created”, a printing process is directly performed by using a raster image.

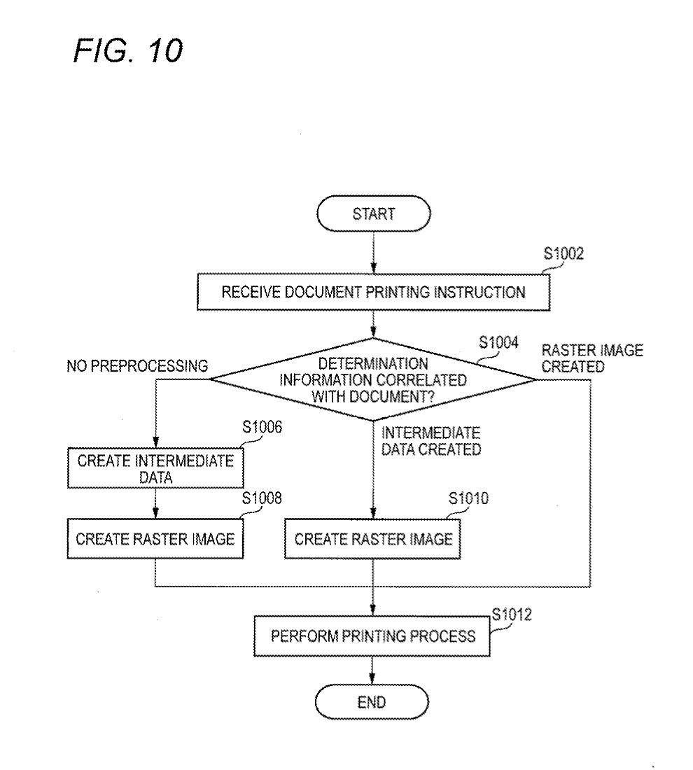

FIG. 10 is a flowchart illustrating a processing example according to Embodiment 3.

In step S1002, the job reception module 155 receives a printing instruction of a document.

In step S1004, determination information correlated with the document is discriminated. If the determination information indicates “no preprocessing”, the flow proceeds to step S1006, if the determination information indicates “intermediate data created”, the flow proceeds to step S1010, and if the determination information indicates “raster image created”, the flow proceeds to step S1012.

In step S1006, the intermediate data creation module 175 creates intermediate data.

In step S1008, the raster image creation module 180 creates a raster image.

In step S1010, the raster image creation module 180 creates a raster image.

In step S1012, the printing apparatus 195 performs a printing process.

### Embodiment 3-2

Data (intermediate data or a raster image) created by the intermediate data creation module 175 or the raster image creation module 180 is preserved in the data storage module 185, and determination information (including information indicating whether or not a determination is completed), processing time and date information, and a job ID are returned from the return module 190 to the document reception module 105 of the document management apparatus 100). In addition, for example, the job ID-intermediate data or raster image correspondence table 700 is stored in the data storage module 185.

The document reception module 105 receives information and delivers the information to the document management module 110 so that each piece of information is added to a related document stored in the storage module 115 as an attribute.

In addition, in a case where the printing due date is near, the preprocessed job ID is added to the printing job, and the printing job is fed from the document management apparatus 100 to the image forming apparatus 150. The image forming apparatus 150 extracts intermediate data or a raster image by using the job ID-intermediate data or raster image correspondence table 700K on the basis of the job ID added to the printing job, and performs a printing process.

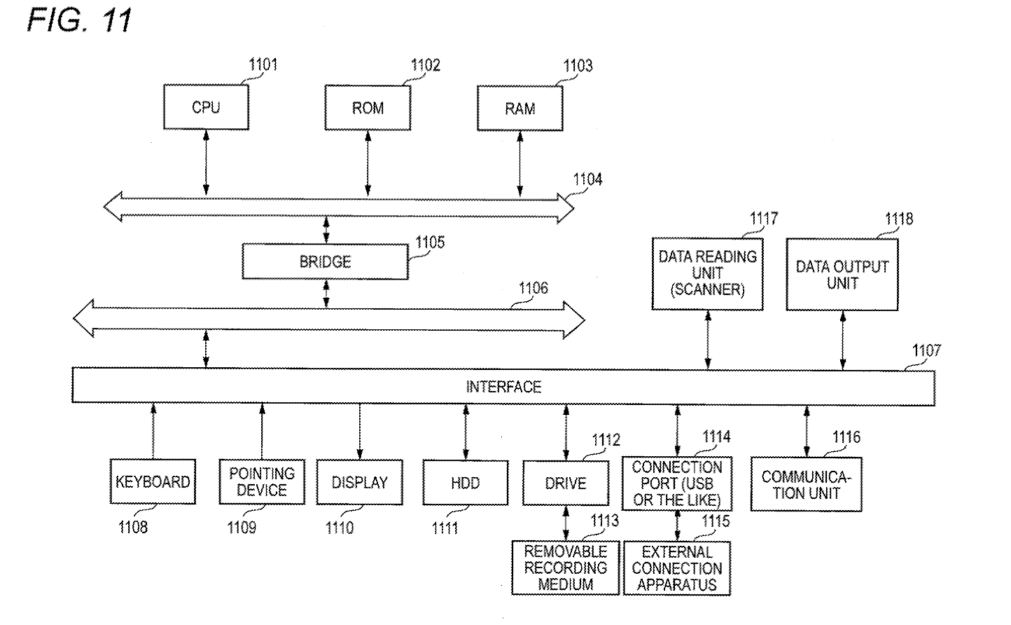

With reference to FIG. 11, a hardware configuration example of the document management apparatus 100 and the image forming apparatus 150 of the present embodiment will be described. A configuration illustrated in FIG. 11 is implemented by, for example, a personal computer (PC) or the like, and is a hardware configuration example including a data reading unit 1117 such as a scanner and a data output unit 1118 such as a printer.

A central processing unit (CPU) 1101 is a controller which executes processes according to a computer program which describes execution sequences of the various respective modules, that is, the document reception module 105, the document management module 110, the document holding module 120, the feeding module 125, the job reception module 155, the job holding module 160, the determination module 165, the job management module 170, the intermediate data creation module 175, the raster image creation module 180, the return module 190, and the like, described in the above embodiments.

A read only memory (ROM) 1102 stores programs or calculation parameters used by the CPU 1101. A random access memory (RAM) 1103 stores programs used for the execution of the CPU 1101 or parameters which are appropriately changed in the execution.

The above-described elements are connected to each other via a host bus 1104 constituted by a CPU bus.

The host bus 1104 is connected to an external bus 1106 such as a peripheral component interconnect/interface (PCI) bus via a bridge 1105.

A keyboard 1108 and a pointing device 1109 such as a mouse are input devices operated by an operator. A display 1110 includes a liquid crystal display, a cathode ray tube (CRT), or the like, and displays a variety of pieces of information as text or image information.

A hard disk drive (HDD) 1111 has a hard disk built therein, drives the hard disk, and records or reproduces a program or information executed by the CPU 1101. The hard disk stores the document 102, the document 104, the attribute table 500, the job ID-intermediate data or raster image correspondence table 700, intermediate data, a raster image, and the like. In addition, a variety of computer programs such as other various data processing programs are stored therein.

A drive 1112 reads data or a program recorded on a removable recording medium 1113 such as a magnetic disk, an optical disc, a magneto-optical disc, or a semiconductor memory which is installed therein, and supplies the data or the program to the RAM 1103 which is connected thereto via the interface 1107, the external bus 1106, the bridge 1105, and the host bus 1104. The removable recording medium 1113 may also be used as a data recording region in the same manner as the hard disk.

A connection port 1114 is a port for connection to an external connection apparatus 1115 and has a connection unit such as a USB, or IEEE1394. The connection port 1114 is connected to the CPU 1101 and the like via the interface 1107, the external bus 1106, the bridge 1105, and the host bus 1104. A communication unit 1116 is connected to a communication line and executes a data communication process with external apparatuses. The data reading unit 1117 is, for example, a scanner, and executes a document reading process. The data output unit 1118 is, for example, a printer, and executes a document data output process.

In addition, the hardware configuration of the document management apparatus and the image forming apparatus illustrated in FIG. 11 shows a configuration example, and the present embodiment is not limited to the configuration illustrated in FIG. 11 and may employ a configuration which executes the modules described in the present embodiment. For example, some modules may be constituted by dedicated hardware (for example, an application specific integrated circuit (ASIC)), some modules may have a form where the modules are present in an external system and are connected via a communication line, and plural systems illustrated in FIG. 11 may be connected to each other via a communication line and be operated in cooperation with each other. In addition, the hardware configuration may be incorporated into a copier, a facsimile, a scanner, a multi-function peripheral (an image processing apparatus having two or more functions of the scanner, the printer, the copier, and the facsimile), or the like.

In addition, the above-described program may be stored on a recording medium, or the program may be provided by using communication means. In this case, for example, the above-described program may be understood as the invention of a “computer readable recording medium recording the program”.

The “computer readable recording medium recording the program” refers to a recording medium which is used to install and execute the program and distribute the program, records the program thereon and is capable of being read by a computer.

In addition, the recording medium includes, for example, “DVD-R, DVD-RW, DVD-RAM, or the like” which is a digital versatile disc (DVD) and is a standard formulated by the DVD forum, “DVD+R, DVD+RW, or the like” which is a standard formulated by DVD+RW, a read only memory (CD-ROM), a CD-recordable (CD-R), a CD-rewritable (CD-RW), or the like as a compact disc (CD), a Blu-ray disc (registered trademark), a magneto-optical disc (MO), a flexible disc (FD), a magnetic tape, a hard disk, a read only memory (ROM), an electrically erasable programmable read-only memory (EEPROM (registered trademark)), a flash memory, a random access memory (RAM), a secure digital (SD) memory card, or the like.

The above-described program or a part thereof may be recorded on the recording medium so as to be preserved or distributed. In addition, the program may be transmitted by communication, for example, through wired networks such as a local area network (LAN), a metropolitan area network (MAN), a wide area network (WAN), the Internet, an intranet, and an extranet, or through wireless communication networks. Further, the program may be transmitted using a combination of the recording media, or may be carried on a carrier.

Further, the above-described program may be a part of another program, or may be recorded on the recording medium along with a separate program. In addition, the program may be recorded on plural recording media so as to be divided. The program may be recorded in any form as long as the program can be recovered through compression, encryption, or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a first conversion unit that converts into intermediate information for printing, a document which has a possibility of being printed;
a second conversion unit that converts the intermediate information into information which can be printed by a printing apparatus; and
a control unit that controls the first conversion unit to perform a process on the document which has the possibility of being printed and controls the second conversion unit not to perform a process in response to the document being not a complete edition and having no possibility that a content thereof is changed.

2. The image processing apparatus according to claim 1, wherein the control unit controls the first conversion unit to perform the process and controls the second conversion unit to perform the process in response to the document which has the possibility of being printed being the complete edition.

3. The image processing apparatus according to claim 1, wherein the control unit controls the first conversion unit to perform the process on the document which has the possibility of being printed and controls the second conversion unit not to perform the process in response to the document being not the complete edition and having a possibility that imposition or page allocation is changed.

4. The image processing apparatus according to claim 1, wherein the control unit controls the first conversion unit to perform the process on the document which has the possibility of being printed and controls the second conversion unit not to perform the process in response to the document being not the complete edition and has a possibility that a process related to a color is changed.

5. The image processing apparatus according to claim 1, wherein the control unit controls the first conversion unit or the second conversion unit to re-perform the process, in response to the document being changed after the process of the first conversion unit or the second conversion unit, and the first conversion unit or the second conversion unit having processed the document before the change of the document.

6. The image processing apparatus according to claim 1, wherein, in response to a printing process of the document being received, the control unit controls the second conversion unit to process the document having been processed by the first conversion unit so that a process result by the second conversion unit is printed by the printing apparatus, and performs control so that a process result by the second conversion unit is printed by the printing apparatus.

7. The image processing apparatus according to claim 1, wherein the complete edition indicates an access right to the document is set to be read-only.

8. A non-transitory computer readable medium storing a program causing a computer to execute a process for image processing, the process comprising:
converting into intermediate information for printing, a document which has a possibility of being printed as a first conversion process;
converting the intermediate information into information which can be printed by a printing apparatus as a second conversion process; and
controlling the first conversion process being performed on the document which has the possibility of being printed and controlling the second conversion process being not performed in response to the document being not a complete edition and having no possibility that a content thereof is changed.
